(19) United States
(12) Patent Application Publication
(10) Pub. No.: US 2025/0358613 A1
(43) Pub. Date: Nov. 20, 2025

(54) SET-UP OF BLE COMMUNICATION BETWEEN A REMOTE CONTROL KEY CASING AND A VEHICLE

(71) Applicant: Valeo Comfort and Driving Assistance, Créteil (FR)

(72) Inventor: Laurent Petel, Créteil (FR)

(73) Assignee: Valeo Comfort and Driving Assistance, Créteil (FR)

(21) Appl. No.: 19/206,520

(22) Filed: May 13, 2025

(30) Foreign Application Priority Data
May 14, 2024 (FR) 2404918

(51) Int. Cl. H04W 12/0471; H04W 4/80; H04W 12/03; H04W 12/47; H04W 12/50

(52) U.S. Cl. CPC H04W 12/0471; H04W 4/80; H04W 12/03; H04W 12/47; H04W 12/50

(57) ABSTRACT

A method for communication between a vehicle remote control key casing and a vehicle. The key casing and the vehicle are configured to communicate using the Bluetooth Low Energy (BLE) and Near Field Communication (NFC) communication protocols. The method includes a pairing of the key casing and the vehicle for the NFC communication protocol. The method includes an exchange, using the NFC communication protocol, of a BLE key between the key casing and the vehicle. The method includes a set-up of a BLE communication between the key casing and the vehicle using the exchanged BLE key.

### TECHNICAL FIELD

This disclosure relates to a method for communication between a vehicle remote control key casing and a vehicle, a computer program for such a remote control key casing and/or a vehicle system, a storage medium for such a program and a remote control key casing configured for such a communication method.

### TECHNICAL BACKGROUND

Vehicle remote control key casings, often referred to as “identifiers” or “key fobs”, are now used for performance of various functions by the vehicle, for example opening the doors and/or starting the vehicle when the user approaches the vehicle. To perform these functions, the key casings are configured to use multiple communication protocols to communicate with the system. For example, the key casing and the system may be configured to communicate using an NFC (which stands for Near Field Communication in the ISO/IEC 14443 standard) communication protocol and a BLE (which stands for Bluetooth Low Energy) communication protocol.

As illustrated in FIG. 1 describing the prior art, for each communication protocol, the key casing 110 is generally paired with the vehicle 120 before communicating with said protocol, in particular to secure the use of the functions. The key casing 110 and the vehicle 120 carry out in particular a first secure pairing S10 for the NFC protocol and a second pairing S11 for the BLE protocol. The second pairing S11 comprises in particular the secure exchange of a shared BLE key between the identifier and the vehicle. A step to increase privileges can be carried out beforehand on the vehicle so that such pairings are authorized by the vehicle.

For the NFC protocol, the pairing S10 is generally less complex because the NFC protocol can only be used at short distances, reducing security risks, in particular identity theft. The NFC pairing S10 can, for example, be carried out once the key casing 110 is put down on a support located inside the vehicle, and is detected on this support by the vehicle. With regard to the BLE protocol, this can be used at longer distances, especially when the user is outside the vehicle, resulting in the use of more complex pairing algorithms (such as the key exchange protocol ECDH, which stands for Elliptic Curve Diffie-Hellman). Indeed, these pairing algorithms generally include cryptography ciphers that take a long time to execute. On the other hand, the BLE pairing S11 can in particular wait for an action S12 by the user on the key casing before starting. Set-up of the BLE communication between the key casing and the vehicle is therefore more time-consuming and complex to achieve. In addition, since the BLE pairing is carried out prior to use of the BLE protocol, it diminishes the responsiveness of the functions to be provided that are then performed on the basis of the set-up BLE communication.

There is therefore a need to improve set-up of a BLE communication between a key casing and a vehicle, in particular to speed up the time for setting up a BLE communication.

### SUMMARY

A method for communication between a vehicle remote control key casing and a vehicle is proposed. The key casing and the vehicle are configured to communicate using the BLE and NFC communication protocols. The method comprises a pairing of the key casing and the vehicle for the NFC communication protocol. The method comprises an exchange, using the NFC communication protocol, of a BLE key between the key casing and the vehicle. The method comprises a set-up of a BLE communication between the key casing and the vehicle using the exchanged BLE key.

The key casing can comprise a non-volatile memory. The exchange of the BLE key can comprise a sending, using the NFC communication protocol, of the BLE key to the key casing by the vehicle, a receiving of the sent BLE key by the key casing, and a storing of the received BLE key in the non-volatile memory by the key casing.

The exchange of the BLE key can further comprise an encrypting of the BLE key before the BLE key is sent. The stored BLE key can be the encrypted BLE key.

The sending can comprise the sending of a command to store the BLE key in the non-volatile memory. The sent command can be encrypted.

The method can further comprise an erasing of the BLE key stored in the non-volatile memory.

The key casing can comprise a BLE component. The set-up of the BLE communication can comprise a waking of the BLE component, a reading of the exchanged BLE key by the woken BLE component, and a carrying out of one or more BLE exchanges between the key casing and the vehicle using the read BLE key.

The vehicle can comprise a support. The pairing of the key casing and the vehicle for the NFC communication protocol can comprise a placing of the key casing on the support of the vehicle.

A first computer program for a key casing is also proposed. The first computer program comprises instructions that, when the program is executed by a processor of the key casing, cause the latter to carry out said method with a vehicle.

A second computer program for a vehicle system is also proposed. The second computer program comprises instructions that, when the program is executed by a processor of the vehicle system, cause the latter to carry out said method with a key casing.

A third computer program comprising the first computer program and the second computer program is also proposed.

A computer-readable storage medium on which the first computer program, the second computer program and/or the third computer program is stored is also proposed.

A vehicle remote control key casing configured to perform BLE and NFC communications with a vehicle is also proposed. The key casing is configured to communicate with the vehicle according to said method.

### BRIEF DESCRIPTION OF THE FIGURES

Non-limiting examples will be described with reference to the following figures:

FIG. 1 illustrates an example of an existing solution for setting up a BLE communication.

FIG. 2 illustrates an example of a flowchart of the method.

FIG. 3, FIG. 4, FIG. 5 and FIG. 6 illustrate examples of a remote control key casing and a vehicle that are configured to perform the method.

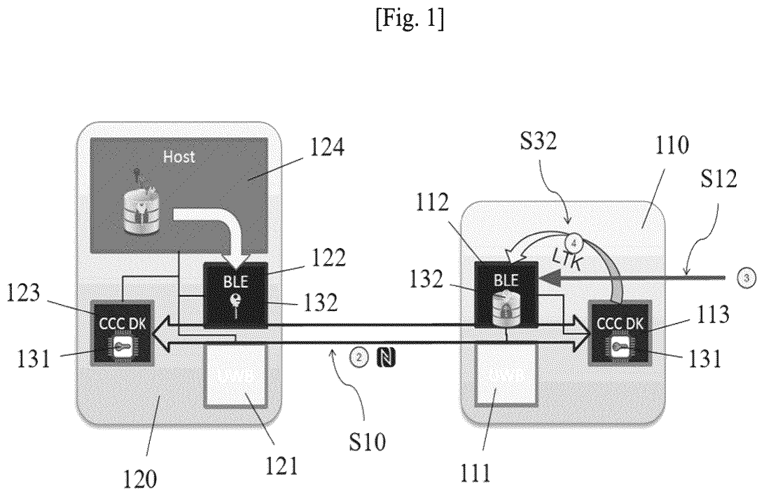

### DETAILED DESCRIPTION

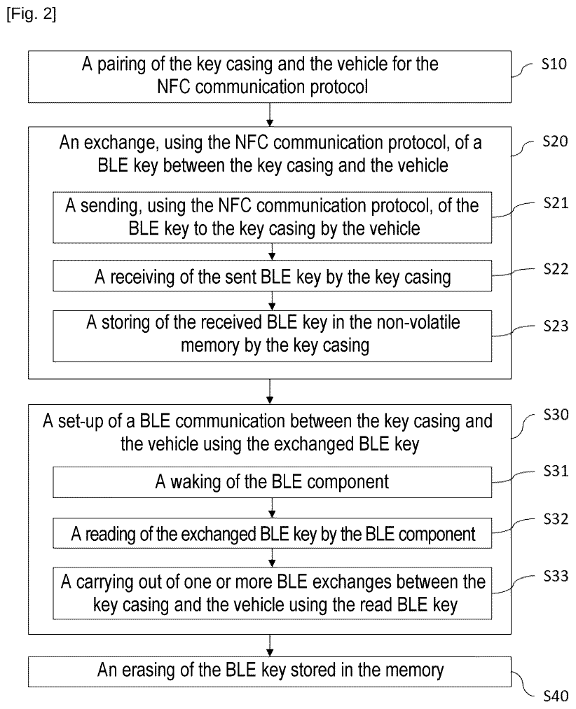

With reference to the flowchart in FIG. 2, a method for communication between a vehicle remote control key casing and a vehicle is proposed. The key casing and the vehicle are configured to communicate using the BLE and NFC communication protocols. The method comprises a pairing S10 of the key casing and the vehicle for the NFC communication protocol. The method comprises an exchange S20, using the NFC communication protocol, of a BLE key between the key casing and the vehicle. The method comprises a set-up S30 of a BLE communication between the key casing and the vehicle using the exchanged BLE key.

The method improves set-up of a BLE communication between the remote control key casing and the vehicle.

This is because the method allows the BLE communication to be set up using the already set-up NFC communication, thereby simplifying and facilitating the BLE pairing process in a secure manner. In particular, since the NFC protocol can only be used at short distances, the risk of identity theft is greatly reduced, and the exchange of the BLE key using the NFC protocol is therefore secure. In addition, by using a simple exchange of the BLE key by the NFC protocol, the method avoids the use of a complex pairing algorithm to carry out the BLE pairing. The BLE key exchange using the NFC protocol is therefore much faster than executing a more complex algorithm such as the ECDH key exchange protocol.

On the other hand, the method improves the responsiveness of the functions to be provided that are then performed on the basis of the set-up BLE communication. This is because the BLE key exchange is carried out prior to use of the BLE protocol, and by accelerating this exchange the method ultimately reduces the time elapsed since the start of a function that uses the BLE protocol and its execution.

The vehicle and the key casing are configured to communicate using the NFC (which stands for Near Field Communication) communication protocol and the BLE (which stands for Bluetooth Low Energy) communication protocol. For each protocol, communication is understood to mean exchanges, for example periodic exchanges, of signals between the key casing and the system of the vehicle according to the communication protocol.

The BLE communication protocol is used by the vehicle and the key casing when the key casing is within a certain perimeter around the vehicle, that is to say exchanges using this BLE protocol (i.e. BLE exchanges) can be carried out within this perimeter. This perimeter can comprise all positions that are at a distance from the vehicle less than or equal to a predetermined distance (for example 40 metres). On a 2D plane embodying the ground, in the absence of any obstacles, this perimeter can be represented by a circle centred on the vehicle and having a radius equal to the predetermined distance.

The NFC communication protocol itself can be used at shorter distances. For example, the NFC protocol can be used by the vehicle and the key casing when the key casing is inside the vehicle. The vehicle can comprise a support inside the passenger compartment, for example close to the dashboard next to the driver. The NFC protocol can be used when the key casing is at a distance of less than one metre from this support (for example a distance of less than twenty centimetres from this support), for example when the key casing is put down on this support located inside the vehicle.

The steps of the method can be performed by the key casing or by the vehicle. Alternatively, one or more steps can be carried out by the key casing and one or more other steps can be carried out by the vehicle. In some examples, some steps can also be carried out by both devices together (key casing and vehicle).

In some examples, the vehicle may have stored multiple key casings. In this case, when a user carrying one of these key casings enters the vehicle, the steps of the method can be performed for this key casing. For example, the method can begin after the user has placed the key casing on the support. When another of the key casings is placed on the support (for example after being placed by the same or another user), the method can be repeated for that other key casing.

The method comprises the pairing S10 of the key casing and the vehicle for the NFC communication protocol. The pairing S10 can be carried out once the user carrying the key casing is in the vehicle. The pairing S10 can be carried out in any way. For example, the pairing S10 can comprise a step in which the user places the key casing on a support provided for this purpose inside the vehicle. The pairing S10 can then comprise a detecting of the key casing on the support by the vehicle. The pairing S10 can also comprise an identifying of the key casing by the vehicle, for example with a storing of a reference of the key casing by the vehicle. The pairing S10 can comprise the exchange of an NFC key (digital key) between the key casing and the vehicle, for example which is then stored in a secure element (NFC component) that each device comprises. Once paired, an NFC communication between the key casing and the vehicle is set up, and the key casing and the vehicle can exchange signals according to the NFC protocol.

The method comprises the exchange S20, using the NFC communication protocol, of a BLE key between the key casing and the vehicle. The exchange S20 is carried out according to the NFC communication protocol, which means that the exchange S20 is carried out by an exchange of one or more signals between the key casing and the vehicle using the NFC communication protocol.

The exchange S20 can be carried out in any way. In some examples, the exchange S20 can comprise steps S21, S22 and S23 illustrated in FIG. 2. The exchange S20 can comprise a sending S21, using the NFC communication protocol, of the BLE key to the key casing by the vehicle. For example, the key casing can comprise a non-volatile memory, and the sending S21 can comprise a sending of a command to store the BLE key in the non-volatile memory. The non-volatile memory can be included in a secure element of the key casing.

The sending S21 can previously comprise a generating of a BLE key and a storing of this BLE key, for example in a memory of the vehicle. The exchanged BLE key can be specific to the key casing. The BLE key can be an encryption key, that is to say a parameter used as input for a cryptographic operation used at the time of subsequent BLE exchanges. It may be symmetrical, and may be encoded in a binary form (for example on at least 128 bits).

The sending S21 can comprise a transmitting of an NFC signal containing the BLE key and/or the store command by the vehicle. For example, the sending S21 can comprise an encoding of the BLE key and/or the store command in the NFC signal, and then a transmitting of this NFC signal.

The exchange S20 can then comprise a receiving S22 of the sent BLE key by the key casing. The receiving S22 can comprise a receiving of the NFC signal transmitted by the vehicle by the key casing, and a reading of the received NFC signal to decode the BLE key and/or the store command that are included in this NFC signal. The exchange S20 can then comprise a storing S23 of the received BLE key by the key casing. For example, the exchange S20 can comprise a storing of the received BLE key in the non-volatile memory of the key casing. The key casing can be configured to automatically store the received BLE key upon receiving such a signal containing such a BLE key. When the sending S21 comprises the sending of a command to store the BLE key, the key casing can be configured to execute this command in order to store the BLE key in the non-volatile memory.

In some examples, the exchange S20 of the BLE key can further comprise an encrypting of the BLE key before the BLE key is sent. In this case, the BLE key sent in step S21 and received in step S22 can be the encrypted BLE key. The stored BLE key can also be the encrypted BLE key in this case. The sending S21 can comprise the sending of a command to store this encrypted BLE key in the non-volatile memory. For example, the key can be encrypted using encryption algorithms such as SCP03 combining AES-128 CBC and CMAC, or AES-128 CCM. Alternatively, the sent store command can be encrypted. In this case, the exchange S20 of the BLE key can further comprise, before step S21, an encrypting of the command to store the BLE key, and the sending S21 can comprise a sending of the encrypted command. For example, the command can be encrypted using encryption algorithms such as SCP03 (combining AES-128 CBC and AES-128 CMAC) or AES-128 CCM.

In other examples, the exchange S20 can be carried out differently, and may not comprise some of these steps S21 to S23, and/or can comprise one or more other additional steps, and/or one or more alternative steps to steps S21 to S23. For example, the BLE key can be generated by the key casing, and can then be sent by the key casing to the vehicle.

The method then comprises the set-up S30 of the BLE communication between the key casing and the vehicle using the exchanged BLE key. In some examples, the set-up S30 of the BLE communication can comprise a waking S31 of the BLE component. In these examples, the BLE component can be switched off before this step. For example, the BLE component may have automatically switched off after a period of inactivity. The BLE component can be woken S31 by the secure element of the key casing, for example once the BLE key is received. Alternatively, the BLE component can be woken S31 after the user has pressed one of the buttons on the key casing.

Once the BLE component is woken, the set-up S30 of the BLE communication can comprise a reading S32 of the BLE key previously exchanged during the NFC exchange, by the woken BLE component. For example, the reading S32 can comprise a sending of the BLE key stored in the non-volatile memory to the BLE component. In some examples, the sending of the BLE key can comprise the sending of a command to read the BLE key to the BLE component by the secure element. As with the sending of the BLE key to the key casing by the vehicle, the BLE key can be encrypted or the read command itself can be encrypted (for example using the same algorithms as previously mentioned). The reading S32 can then comprise a storing of the BLE key (for example with its decryption) in a memory of the BLE component.

After the reading S32 of the BLE key, the set-up S30 of the BLE communication can comprise a carrying out S33 of one or more BLE exchanges between the key casing and the vehicle using the read BLE key. Each exchange between the two devices (key casing and vehicle) can comprise an encrypting of a BLE signal by a first of the two devices using the exchanged BLE key, a sending of the encrypted BLE signal by the first of the two devices to the second, a receiving of the sent BLE signal by the second of the two devices, and a decoding of the received BLE signal by the second of the two devices using the exchanged BLE key.

In other examples, the set-up S30 of the BLE communication can be carried out differently, and may not comprise some of these steps S31 to S33, and/or can comprise one or more other additional steps, and/or one or more alternative steps to steps S31 to S33. For example, the BLE component may already be woken at the time of this step being performed, and the set-up S30 of the BLE communication may directly comprise step S32 of reading the exchanged BLE key.

In some examples, once the BLE key is received by the BLE component, the method can comprise an erasing S40 of the BLE key stored in the non-volatile memory. For example, the BLE key may be stored at a specific location in the non-volatile memory, and the erasing S40 can comprise a modifying of the value stored at this specific location to overwrite the value of the BLE key (for example with a null value). The erasing of the BLE key improves the security of the set-up BLE communication by preventing subsequent malicious recovery of the BLE key.

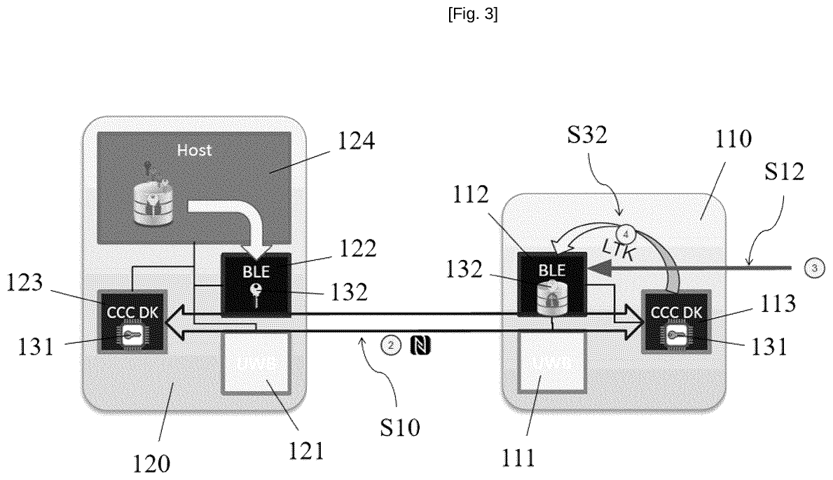

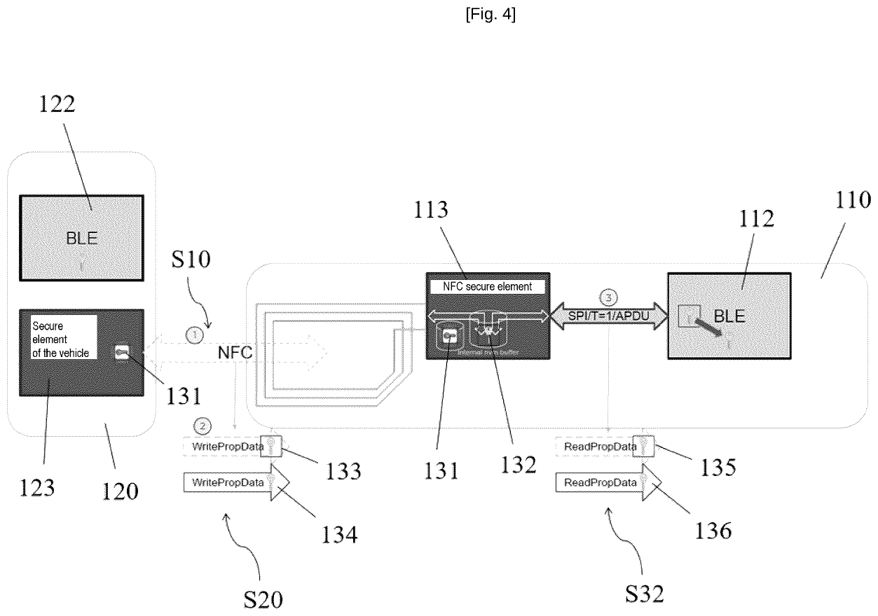

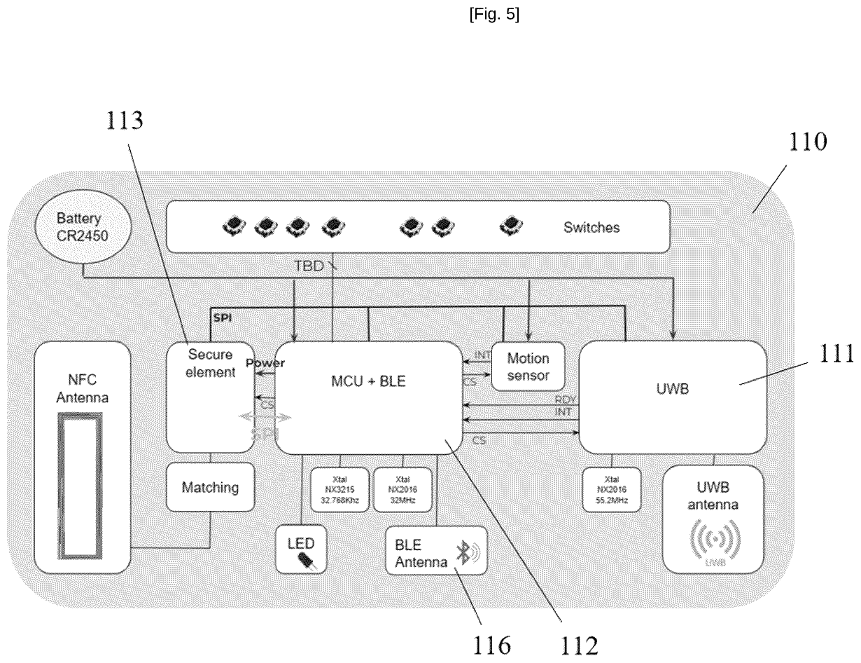

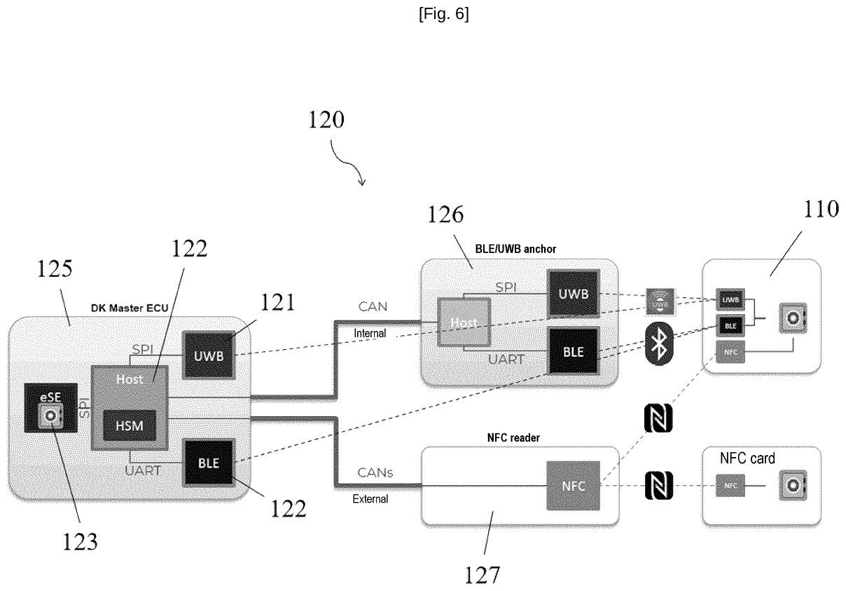

Examples will now be described with reference to FIGS. 3 to 6.

FIG. 3 illustrates an example of a vehicle remote control key casing 110 configured to perform BLE and NFC communications with a vehicle 120. The key casing 110 is configured to communicate with the vehicle 120 according to the method of FIG. 2. The key casing 110 comprises a UWB component 111 for carrying out a UWB communication with the vehicle 120. The key casing 110 also comprises a secure element 113 configured to carry out the NFC communication with the vehicle 120. The secure element 113 can comprise a digital key 131 that is used to carry out this NFC communication with the vehicle 120. The key casing 110 also comprises a BLE component 112 configured to carry out BLE exchanges with the vehicle 120.

The vehicle 120 can be a car, a motorcycle, a lorry, or more generally any land vehicle. The vehicle 120 comprises a BLE component 122 configured to carry out BLE exchanges with the key casing 110. The BLE component 122 can comprise a BLE transceiver. The BLE component 122 comprises a memory in which the BLE key 132 exchanged with the key casing 110 is stored. The vehicle 120 comprises a UWB component 121 for carrying out a UWB communication with the key casing 110. The vehicle 120 comprises a secure element 123. The secure element 123 can comprise a digital key 131 that is used to carry out the NFC communication with the vehicle. The vehicle 120 also comprises a host component 124. The host component 124 is configured to generate the BLE key 132 exchanged between the vehicle 120 and the key casing 110 and stored on the BLE component 122. These various components of the vehicle can be integrated together in a system.

The secure element 123 of the vehicle 120 and the secure element 113 of the key casing 110 can be configured to carry out NFC exchanges after the pairing S10 of the two devices for this NFC communication protocol. In particular, one of these NFC exchanges can include the BLE key 132 to exchange this BLE key 132 between the two devices. Once exchanged, the BLE key 132 can be read S32 by the BLE component 112. The reading S32 of the BLE key 132 can comprise the storing of the BLE key 132 in memory by the BLE component.

FIG. 4 illustrates an example of implementation of the method by a key casing 110 and a vehicle 120. The key casing 110 comprises a BLE component 112 and a secure element 113. The vehicle 120 also comprises a BLE component 122 and a secure element 123. The method comprises the pairing S10 of the key casing 110 and the vehicle 120 for the NFC communication protocol. The pairing S10 is carried out once the user carrying the key casing 110 is in the vehicle 120, and the user has placed the key casing on a support provided for this purpose inside the vehicle. The pairing S10 comprises a detecting of the key casing 110 on said support by the vehicle 120. The pairing S10 is carried out by the secure element 113 of the key casing and the secure element 123 of the vehicle 120, on the basis of a digital key 131. Once paired, an NFC communication between the key casing and the vehicle is set up, and the key casing 110 and the vehicle 120 can exchange signals according to the NFC protocol.

The method then comprises the exchange S20, using the NFC communication protocol, of a BLE key 132 between the key casing 110 and the vehicle 120. The exchange S20 is carried out according to the NFC communication protocol, which means that the exchange S20 is carried out by way of an exchange of at least one signal between the key casing 110 and the vehicle 120 according to the NFC communication protocol. The exchange S20 comprises the sending, using the NFC communication protocol, of a command to store the BLE key 132 in the non-volatile memory of the secure element 113 to the key casing 110 by the vehicle 120. In some examples, the sent BLE key can be encrypted. In this case, the store command may not be encrypted 133. Alternatively, the sent store command can be encrypted 134. In this case, the BLE key of the store command may not be encrypted. The exchange S20 then comprises an execution of the received command 133, 134 by the key casing 110, leading to a storing of the BLE key 132 in the non-volatile memory of the secure element 113.

The method then comprises the set-up of the BLE communication between the key casing and the vehicle using the exchanged BLE key. The set-up of the BLE communication comprises a waking of the BLE component 112 and then a reading S32 of the exchanged BLE key 132 by the woken BLE component 112. The reading S32 comprises an execution of a command to read the stored BLE key 132 on the secure element 113. As with the sending of the BLE key to the key casing by the vehicle, the BLE key can be encrypted in the read command 135, or the read command itself can be encrypted 136. The reading S32 can then comprise a storing of the BLE key 132 (for example with its decryption) in a memory of the BLE component 112.

After the reading S32 of the BLE key, the set-up S30 of the BLE communication can comprise a carrying out of one or more BLE exchanges between the key casing 110 and the vehicle 120 using the BLE key 132. Once the BLE key 132 is received by the BLE component 112, the method can optionally also comprise an erasing of the BLE key 132 stored in the non-volatile memory of the secure element 113, in order to improve the security of the set-up BLE communication.

FIG. 5 illustrates an example of a vehicle remote control key casing 110. The vehicle remote control key casing 110, or “identifier”, can comprise a protective casing enclosing the components of the key casing. The protective casing can comprise plastic, metal and/or rubber plastic. The key casing 110 can comprise a logo, for example made of metal. The logo can be arranged on the outer shell of the protective casing, and/or the logo can represent a manufacturer's brand. The key casing 110 can comprise a metal insert inside the protective casing, which makes it possible to open and/or start the vehicle 120 manually, by inserting and manipulating the insert in a respective lock of the vehicle 120.

The key casing 110 comprises a BLE component 112 that is configured to carry out BLE exchanges with a vehicle and that comprises, for example, a microprocessor. The key casing 110 also comprises an antenna 116 connected to the BLE component 112. The antenna 116 is configured to transmit or receive BLE signals. The microprocessor of the BLE component 112 can have a computer program in memory that allows BLE communications and the provision of various specific functions. The BLE component 112 can have the BLE key 132 exchanged with the vehicle 120 in memory. The key casing 110 also comprises a UWB component 111 for carrying out a UWB communication with a vehicle.

FIG. 6 illustrates an example of a vehicle 120 configured to perform the method. The vehicle 120 comprises a vehicle system 125. The vehicle system 125 comprises the BLE component 122, the UWB component 121, the secure element 123 and the host component 124. The vehicle system 125 also comprises at least one BLE/UWB anchor 126, each comprising a respective UWB component and a respective BLE component. Each BLE/UWB anchor 126 is configured to communicate with the key casing 110 using the UWB and BLE communication protocols. The vehicle system 125 also comprises the support located inside the vehicle on which the key casing 110 can be put down. The support comprises an NFC component. The NFC pairing can be carried out once the key casing 110 is put down on this support.

1. A method for communication between a vehicle remote control key casing and a vehicle, the key casing and the vehicle being configured to communicate using the BLE and NFC communication protocols, the method comprising:
pairing of the key casing and the vehicle according to the NFC communication protocol;
exchanging, using the NFC communication protocol, a BLE key between the key casing and the vehicle; and
setting-up a BLE communication between the key casing and the vehicle using the exchanged BLE key.

2. The method according to claim 1, wherein the key casing comprises a non-volatile memory, wherein the exchange of the BLE key comprising:
sending, using the NFC communication protocol, the BLE key to the key casing by the vehicle;
receiving of the sent BLE key by the key casing; and
storing of the received BLE key in the non-volatile memory by the key casing.

3. The method according to claim 2, wherein exchanging the BLE key further comprises encrypting the BLE key before the BLE key is sent, wherein the stored BLE key is the encrypted BLE key.

4. The method according to claim 2, wherein sending the BLE key comprises sending a command to store the BLE key in the non-volatile memory, wherein the sent command is encrypted.

5. The method according to claim 2, further comprises:
erasing the BLE key stored in a non-volatile memory.

6. The method according to claim 1, wherein the key casing comprises a BLE component, wherein setting-up the BLE communication comprises:
waking of the BLE component;
reading the BLE key exchanged by the woken BLE component; and
carrying out one or more BLE exchanges between the key casing and the vehicle using the read BLE key.

7. The method according to claim 1, wherein the vehicle comprises a support, the pairing of the key casing and the vehicle for the NFC communication protocol comprising:
placing of the key casing on the support of the vehicle.

8. A non-transitory computer readable medium comprising a computer program for a key casing and/or vehicle system comprising instructions that, when the program is executed by a processor, cause the latter to carry out the method according to claim 1.

9. (canceled)

10. A vehicle remote control key casing configured to perform BLE and NFC communications with a vehicle, the key casing being configured to communicate with the vehicle according to the method as claimed in claim 1.
